(19) United States
(12) Patent Application Publication
(10) Pub. No.: US 2006/0023692 A1
(43) Pub. Date: Feb. 2, 2006

(54) Exemplary method and apparatus for creating an efficient storage area network

(76) Inventor: Tom Fleissner, Morgan Hill, CA (US)

Correspondence Address: Tom Fleissner, 6387 Little Uvas Road, Morgan Hill, CA, 95037, US

(21) Appl. No.: 11/014,794

(22) Filed: Dec. 15, 2004

Related U.S. Application Data
(60) Provisional application No. 60/591,366, filed on Jul. 19, 2004.

(51) Int. Cl. H04L 12/28

(52) U.S. Cl. 370/351

(57) ABSTRACT

An exemplary system for the creation of an efficient and cost effective storage area network through the use of a SAN CARD and top bus.

### CLAIM OF PRIORITY

This application incorporate by reference and claims priority to U.S. Provisional Application No. 60/591,366

### BRIEF SUMMARY OF THE INVENTION

This invention described an exemplary method and apparatus for the creation of an efficient and inexpensive storage area network. This storage are network allows the client to easily create a storage area network by plugging in the SAN CARD and compatible NIC card, described below into a server and attaching one or more mass storage devices directly to the SAN CARD. The ease of creation combined with the reduced number of components greatly reduces the cost of this network. Further, the use of a dedicated secondary channel substantially increases the date throughput of the network.

### BRIEF DESCRIPTION OF THE DRAWINGS

FIG. 1 illustrates a simple peer to peer computer network.

FIG. 2 illustrates a simple host/servant computer network.

FIG. 3 illustrates a typical client/server network.

FIG. 4 illustrates a modern storage are network.

FIG. 5 illustrates a modern storage area network.

FIG. 6 illustrates a SAN CARD.

FIG. 7 illustrates a logical diagram of a SAN CARD.

FIG. 8 illustrates an ASIC diagram of the SAN CARD.

FIG. 9 illustrates a physical diagram of the storage area network.

FIG. 10 illustrates an ASIC of a SAN CARD with Top Bus

FIG. 11 is a flow diagram of the SAN System.

### DETAILED DESCRIPTION OF THE EMBODIMENTS

The networking together of multiple computer systems marked a substantial milestone in the evolution of computer technology. For purposes of this disclosure, a computer network is two or more computers connected together to share resources and/or data. There are numerous types of networks in common usage.

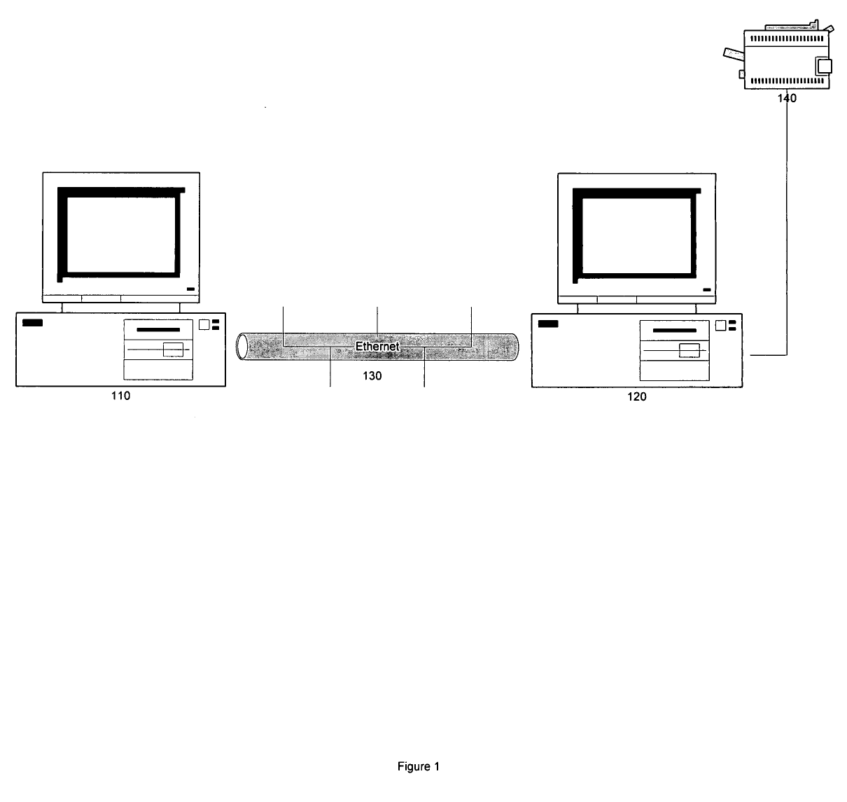

The simplest type of network is a direct, peer to peer network as shown in FIG. 1. In FIG. 1, two computers are connected together. Computer 110 is the host computer. Computer 120 is the servant computer. Computers 110 and 120 are connected to each other through Ethernet cable 130. Computer 110 controls Computer 120 and has access to its hard drives, screen, memory modules, etc. For example, Computer 110 could execute programs, print to Printer 140, or transfer files to and from Computer 120.

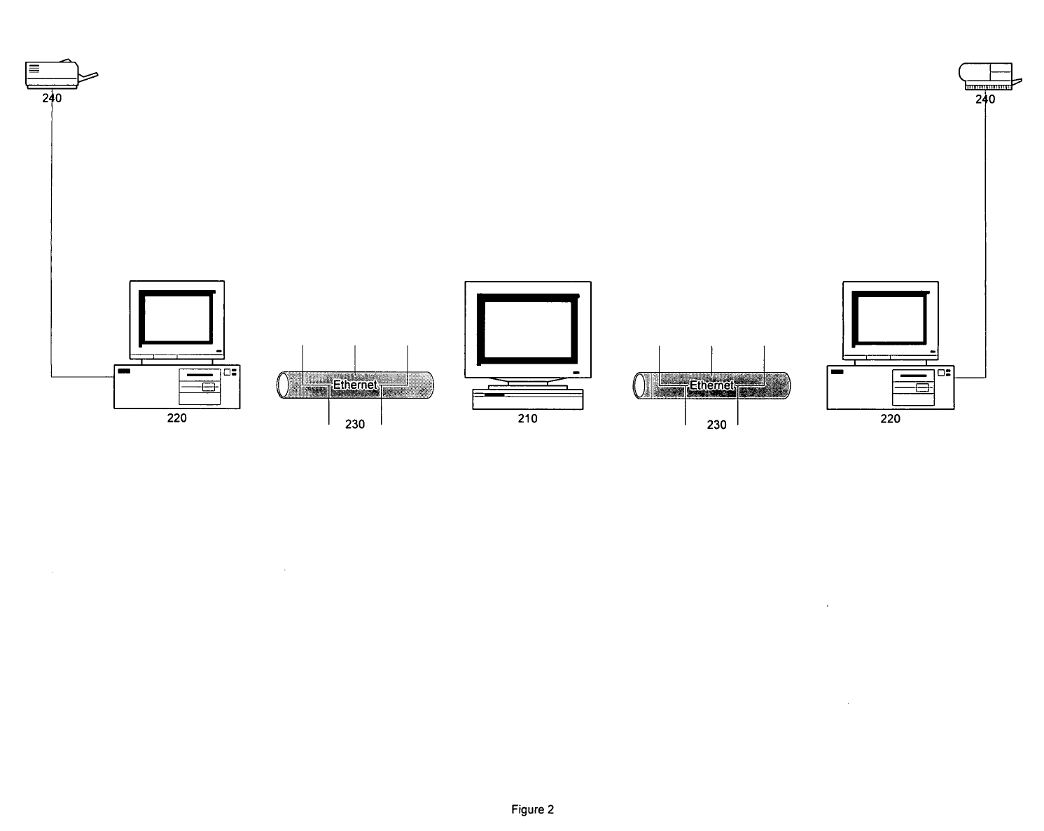

The simple host/servant computer network configuration was a great advance, but still very limited in many fundamental areas. Though, as shown in FIG. 2, it was possible for the Host Computer 210 to be connected to one or more Servant Computer 220 via Ethernet Cable 230 in most early networking implementations, Host Computer 210 could generally only communicate with one Servant Computer 220 at a time. Further, the Host Computer 210 was limited in the number of Servant Computer 220 that it could communicate with. Finally, the Servant Computer 220 was generally unaware of the existence of other Servant Computer 220 and could not communicate directly with them.

The modern form of networked computers is known as a decentralized area network or client/server configuration. For purposes of this disclosure a server is a computer or device on a network that manages network resources. The client is a computer system or process that requests service from another computer system or process (server). A switch is a device that filters and forwards packets between x-AN segments.

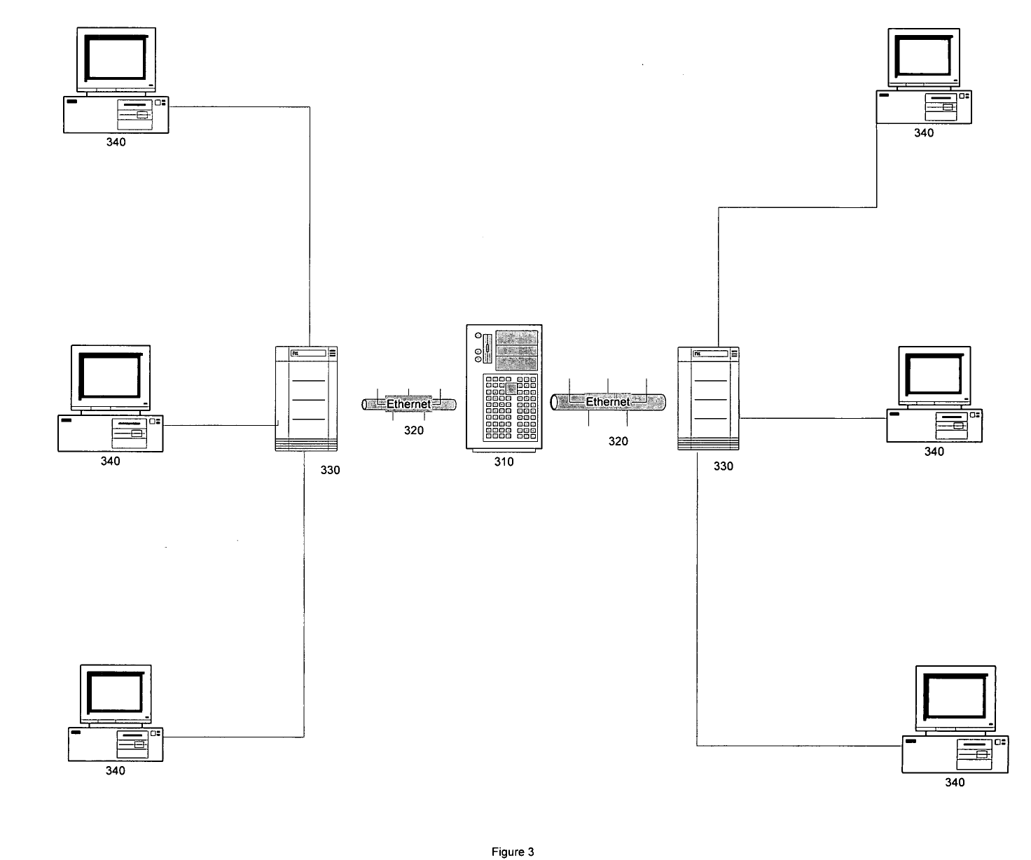

FIG. 3 illustrates an example of a typical client/server network comprising Server 310, Ethernet Connectivity 320, Switch 330, and Client 340.

Client/server networks came in numerous varieties includes, not no limited to Local Area Networks (LAN), Wide Area Networks (WAN), Campus Area Networks (CAN), Metro Area Networks (MAN), and Home Area Networks (HAN), collectively known as x-AN.

As a necessary result of the increasing popularity of client/server networks, storage needs have increased concordantly. One solution has been to increase the capacity of mass storage devices of the computers in the networks. This solution proved to be of limited value as any computer quickly reaches the limit of the number of mass storage devices it can support. Further, high end mass storage devices, i.e. storage devices with more than twice the average storage capacity, have a substantially higher cost per gigabyte, than more commonly available mass storage devices, thus making them prohibitively expensive for most applications.

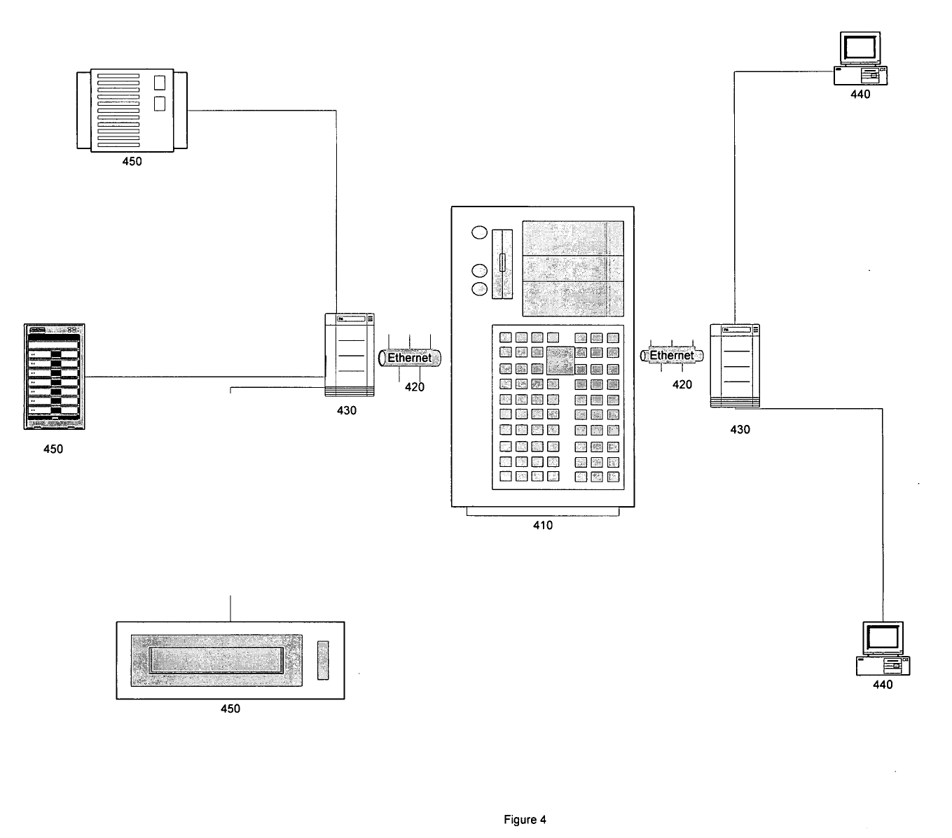

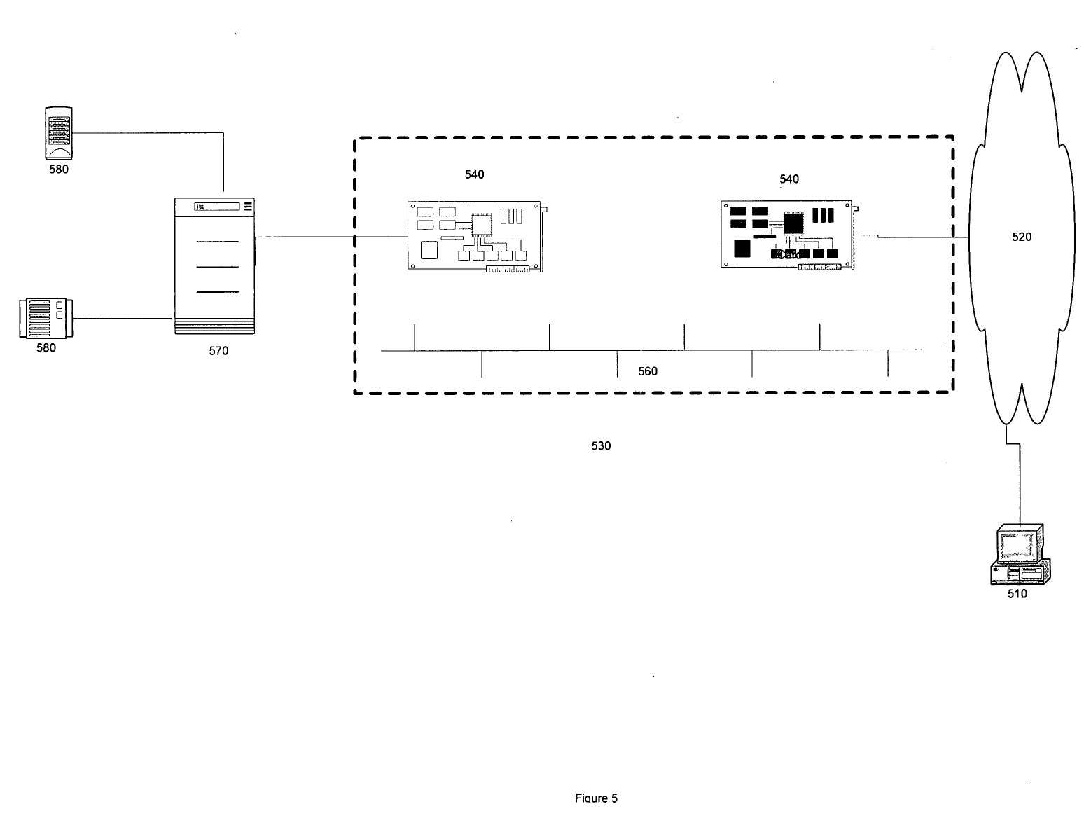

The modern solution is a storage area network or SAN. A SAN is a back-end network connecting storage devices via peripheral channels such as SCSI, SSA, ESCON and Fibre Channel as shown in FIG. 4. FIG. 4 illustrates common implementation of a SAN which includes one or more Storage Devices 450 connected to External Switch 430. External Switch 430 is connected to a host bus adaptor residing within Server 410. The Host bus adaptor uses the bus to communicate with the Ethernet Card which the server uses to communicate with the rest of the x-AN Network as shown in FIG. 5.

For purposes of this disclosure, a switch is a device that filters and forwards frames or packets between x-AN segments, Switches are found at the gateway (a network point that acts as an entrance to another network) levels of a network where one network connects with another and at the sub network level where data is being forwarded close to its destination or origin. A switch may also include the function of the router, a device or program that can determine the route and specifically what adjacent network point the data should be sent to. A switch is a simpler and faster mechanism than a router, which requires knowledge about the network and how to determine the route. A switch is not always required in a network. In a SAN, the switches determines from which mass storage device the server will obtain information.

For purposes of this disclosure, the host bus adaptor provides an interface between the system memory and the computer bus as well as the fibre channel and switch.

Thus in a common implementation of a SAN, as seen in FIG. 5, the user queries the server for information. The query originates with Client Computer 510. An Ethernet is a very common method of networking computers in a LAN using copper or fiber cabling. Some common implementations of Ethernet will handle approximately 10 megabits per second, 100 megabits per second, or 1 gigabit per second respectively, and can be used with almost any kind of computer. Said query goes through Network 520 and reaches server 530 via Ethernet Card 540. Ethernet Card 540 sends the query via Computer Bus 550 to Host Bus Adaptor 560 which translates the query in to a form readable by the components of the San Network. The query reaches Switch 570. Switch 570 determines which device to route the query to. Once the decision to made, the query goes to the appropriate Storage Device 580. Storage Device 580 obtains the necessary information pursuant to the user query. The requested data travels along essentially the reverse path back to the user.

This system has worked adequately for many applications. However there are some limitations and bottlenecks, which once addressed, will reduce costs, increase transmission speeds, and simplify this system.

One limitation occurs between the host bus adaptor and the SAN switch. It is almost axiomatic that multiple devices slow transmission speeds as well as increase financial costs.

The second limitation is the transmission of data from the storage device to the user through the bus connecting the host bus adaptor and Ethernet card. The data shares the same path as all of the other data being transferred from one point to another within the server. Consequently, the bus is not optimized for any particular type of data transmission.

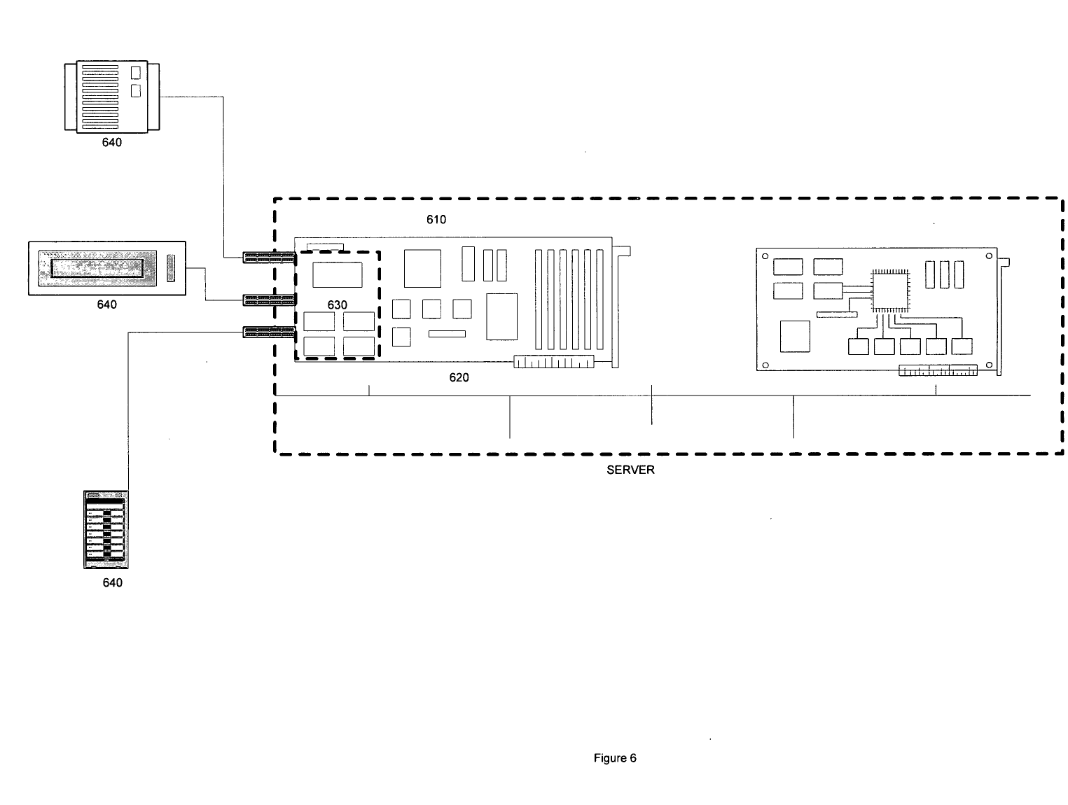

The invention herein solves this problem by creating an exemplary system comprising a combination HBA-Switch card hereinafter the SAN CARD as illustrated in FIG. 6. Referring to FIG. 6, SAN CARD 610 combines the functionality of Host Bus Adaptor 620 and Switch 630. Storage Device 640 plugs directly into SAN CARD 610.

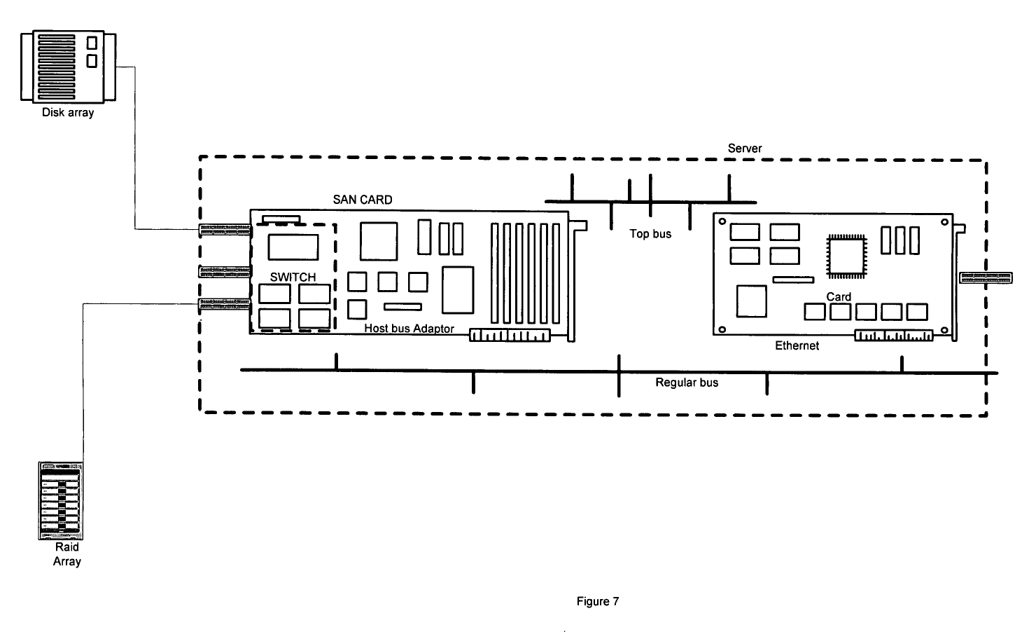

Referring to FIG. 7, FIG. 7 illustrates a logical diagram of one embodiment of the SAN CARD. In this embodiment, the SAN CARD is composed of one or more Transceivers 710, a Framer 720 for each Transceiver 720, Packet Routing Logic 730, Host Bus Adaptor functionality 740, and embedded CPU 750, a PCI BUS 760, and sufficient RAM 770.

For purposes of this disclosure, a transceiver, a combination of the words transmitter and receiver, is the set of electronics that send and receive signals on the Ethernet media system. Transceivers may be small outboard devices, or may be built into an Ethernet port. Also called Media Attachment Unit, or MAU. A framer converts the data coming from the Storage Device into frames which are the basic unit of communication between an N-port and an F-port. The invention follows the ANSI T11.3 (Rev 4.3) Interconnection Standard. Frames are composed of a starting delimiter (SOF), a header, the payload, the Cyclic Redundancy Check (CRC), and an ending delimiter (EOF). The SOF and EOF contain the Special Character and are used to indicate where the frame begins and ends. The 32-byte header contains information about the frame, including the S_ID, D_ID, routing information, the type of data contained in the payload, and sequence/exchange management information. The payload contains the actual data to be transmitted, and may be 0-2112 bytes in length. The CRC is a 4-byte field used for detecting bit errors in the received frame.

For purposes of this disclosure a packet is a unit of data sent across a network. When a large block of data is to be sent over a network, it is broken up into several packets, sent, and the reassembled at the other end. Packets often include checksum codes to detect transmission errors. The exact layout of an individual packet is determined by the protocol being used. The packet routing determines the route that each packet will take.

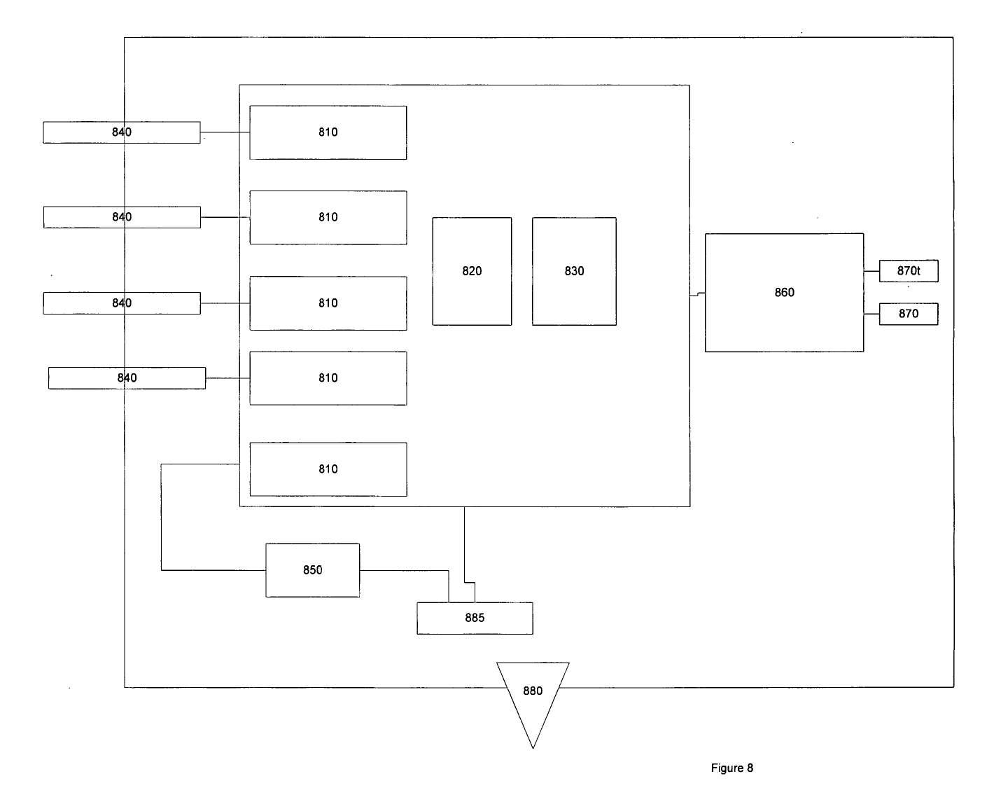

Referring to FIG. 8, FIG. 8 illustrated an ASIC (Application-Specific Integrated) diagram on the SAN CARD. An ASIC is a chip designed for a particular application. ASICs are commonly used in networking devices to maximize performance with minimum cost. The SAN CARD ASIC consists of the functionalities of Framer 810, Frame Routing 820, and Switch Logic 830. The remaining functionality such as Transceiver 840, Host Bus Adaptor 850, CPU 860, RAM 870, PCI Bridge 870 and PCI bus 880 are found elsewhere within the server.

A substantial throughput can be recognized through the addition of one or more exemplary additional communications channel between the SAN CARD and the Ethernet Card. In one embodiment of the invention, the dedicated secondary communications channel is called a top bus.

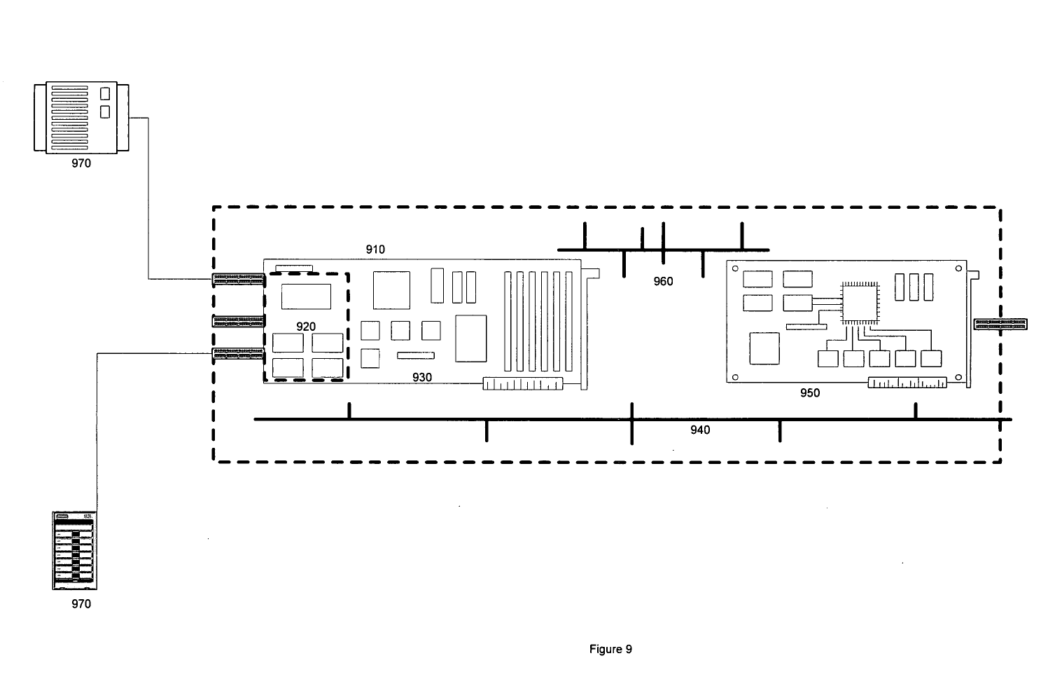

Referring to FIG. 9, FIG. 9 illustrates a physical representation of another embodiment of the SAN CARD. SAN CARD 910 combines the functionality of Switch 930 and Host Bus Adaptor 930. Regular PCI Bus 940 carries mostly command and control information between SAN CARD 910 and Ethernet Card 950. Top Bus 960 is configured and optimized to carry large amount of data between SAN CARD 910 and Ethernet Card 970 which originated in Storage Device.

The general invention herein disclosed related to exemplary method and apparatus for increasing the transmission speed or throughput from one network to another through the use of a two or more network interface cards which have been specifically configured with a dedicated communication channel, to wit, a top bus. For purposes of this disclosure, a network interface card is any interface card which provides external connectivity to the server.

In the current embodiment of the invention, the invention disclosed herein is a combination of a first card to communicate with an x-AN; a second card configured to communicate with an x-AN computer network, and one or more dedicated communication channels between said network interface cards.

In a first embodiment of the invention, the first card is configured as a host bus adaptor designed to communicate with a SAN; the second card is an Ethernet card. In a second embodiment of the invention, the first card is a SAN CARD to wit: a host bus adaptor and switch combination; and more specifically a fibre channel switch.

In a third embodiment of the invention, the dedicated communication channel is a top bus such as PCI, ESCON or fibre channel.

In a fourth embodiment of the invention the SAN CARD is one card which incorporates the functionality of the host bus adaptor and Ethernet card thus eliminating the need for the communications channels

In a fifth embodiment of the invention, the SAN CARD includes the fibre channel switch, the host bus adaptor, and Ethernet card.

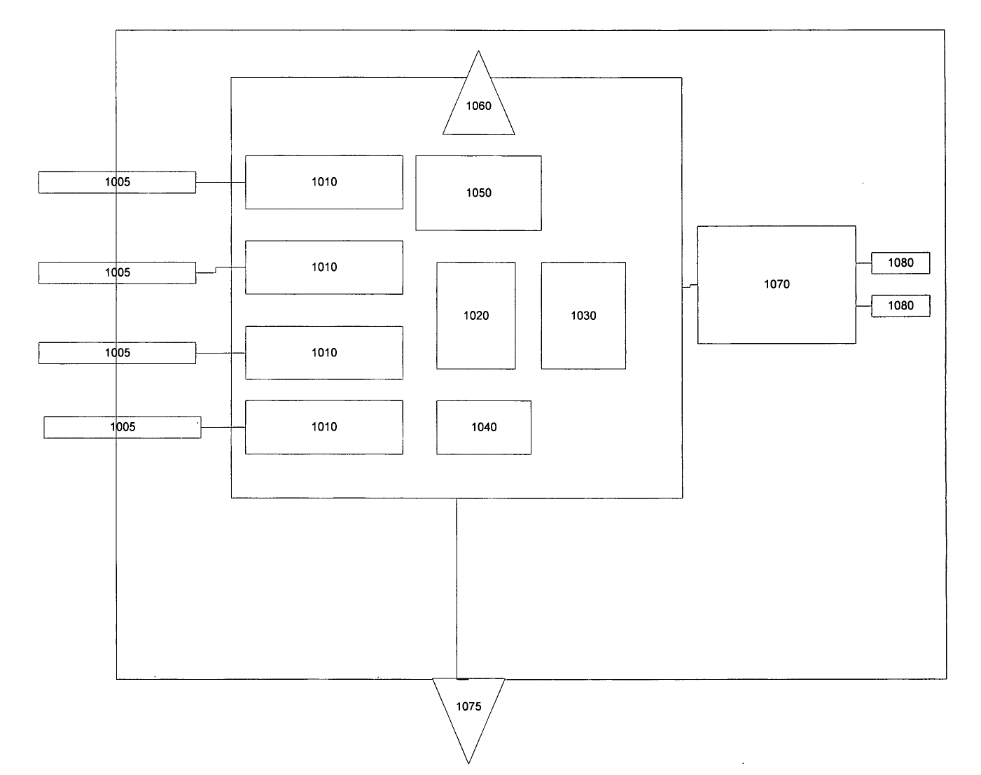

Referring to FIG. 10, FIG. 10 illustrates an ASIC of one embodiment of the SAN CARD 1005 utilizing a top bus. The ASIC includes functionality for Framer Logic 1010, Frame Routing Logic 1020, Switch Logic 1030, Host Bus Adaptor Logic 1040, and Top Bus Interface Logic 1050. The remainder of SAN CARD 1005 includes Top Bus 1060, CPU 1070, and RAM 1080

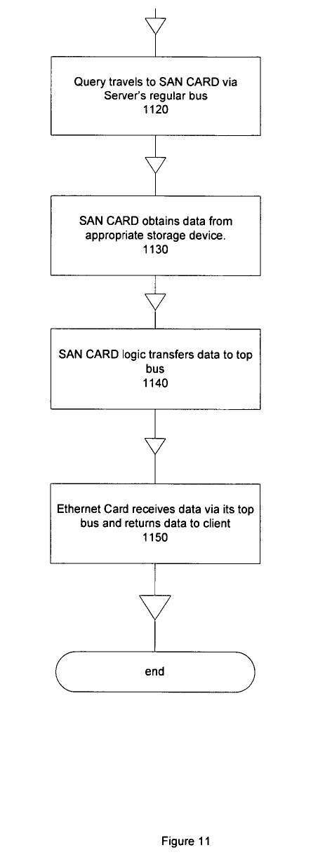

Referring to FIG. 11, at Step 1110 the Ethernet card obtains the client request. At step 120, said client request travels to the SAN Card via the Servers' regular bus. The SAN CARD obtains data from the appropriate storage device at step 1130. At step 1140, the SAN CARD logic transfers data to the top bus. At Step 1150, the Ethernet card received data via its top bus and returns data to the client.

What is claimed is:

1. A network interface card configured to provide connectivity between one or more mass storage devices and a computer server composed of one or more transceivers configured to send command and control information to the mass storage devices from the computer server and received data from the mass storage devices; at least one framer for each transceiver, said framer being configured to convert data from mass storage devices into identifiable units of data; packet routing logic configured to route the packets to the appropriate communications channel, host bus adapter functionality configured to permit the server to communicate with the mass storage devices, a CPU, memory, and a connectivity means between said network interface card and the server's main communications channel.

2. The network interface card of claim one, where the network interface card is further composed of a second connectivity means configured to carry data between the first network interface card and a second network interface card, said second network interface card being configured as an Ethernet card capable of receiving data through a secondary data channel.

3. The second connectivity means of claim 2, where said connectivity means is configured to connect to a dedicated communications channel.

4. The communications channel of claim 3, where said communications channel is configured to transmit large amounts of data originating from mass storage devices.

5. A storage are network composed of one or more mass storage devices; a computer server composed of a first network interface card configured as a SAN CARD, a connectivity means between the mass storage devices and the SAN CARD, a second network interface card configured as an Ethernet Card, a communication means between the two network interface cards configured as a data bus.

6. The storage area network of claim 5, where the storage area network is further composed of a second communication means between the two network interface cards, where the second communication means is a dedicated communication channel configured to carry data originating from mass storage devices.

7. The storage are network of claim 6, where the second network interface card is configured to received data through a secondary communication means.

8. A method efficient obtaining data from a storage are network composed of the following steps: Obtaining a user request from a client machine; said user request is routed to the server via the network interface card; sending the user request through the main communications channel to the SAN CARD, said communications channel being configured as a data bus; sending the request from the SAN CARD to the appropriate mass storage device; transmitting the data and command and control information from the mass storage device to the SAN CARD; framing the data into units for transmission to the network interface card, routing the data to one or more communications channel.

9. The method in claim 8 where the communications channel is a single data bus

10. The method in claim 8, where the communications channels are composed of a first data bus, where the first data bus is not specifically optimized to carry any particular type of date; a second communications channel configured to carry mass storage device data from the SAN CARD to the Ethernet Card.

11. The method of claim 10 composed of the further steps of routing the command and control date to the first data bus, and the large data flow through the second communications channel.
